(19) United States
(12) Patent Application Publication
(10) Pub. No.: US 2022/0335352 A1
(43) Pub. Date: Oct. 20, 2022

(54) SYSTEM AND METHOD FOR MANAGING CONSTRUCTION AND MINING PROJECTS USING COMPUTER VISION, SENSING AND GAMIFICATION

(71) Applicant: INVENTO, INC, San Francisco, CA (US)

(72) Inventor: Anirudh Reddy TIKKAVARAPU, San Francisco, CA (US)

(73) Assignee: INVENTO, INC, San Francisco, CA (US)

(21) Appl. No.: 17/720,149

(22) Filed: Apr. 13, 2022

Related U.S. Application Data
(60) Provisional application No. 63/175,417, filed on Apr. 15, 2021.
(60) Provisional application No. 63/175,434, filed on Apr. 15, 2021.

(51) Int. Cl. G06Q 10/06; G06Q 50/02; G06Q 50/08

(52) U.S. Cl. CPC G06Q 10/06312; G06Q 50/02; G06Q 50/08; G06Q 10/0635; G06Q 10/0637; G06Q 10/06393

(57) ABSTRACT

A system and method for managing construction and mining projects through a gamification process using computer vision and inertial sensing is disclosed. The system and method include detecting automatically, a plurality of machine-operations and work-activities by an electronic computing device mounted on a construction or mining heavy machine. The electronic computing device comprises at least one camera and one six-axis inertial sensor and is configurable to perform computer vision and machine learning through neural networks and state-machine logic for detecting the plurality of machine-operations and work-activities of the construction or mining heavy machine and gamifying construction and mining work-activity management based on the plurality of machine-operations and work-activities.

### PRIORITY STATEMENT

The present application hereby claims priority from U.S. provisional application No. 63/175,417 and 63/175,434 filed on 15 Apr. 2021, the entire contents of which are incorporated herein by reference.

### FIELD

The present disclosure generally relates to data analytics and machine learning methods implemented for monitoring heavy construction and mining machines and more particularly to a system and a method for managing construction and mining projects using computer vision and inertial sensing for heavy machines with moving parts along with gamification.

### BACKGROUND

Heavy equipment or machines are used for various purposes in large construction and mining projects. Some examples of heavy machines are excavators, backhoes, bulldozers, trenchers, loaders, tower cranes, dump trucks, etc. In large construction and mining projects, it is important to measure the productivity, efficiency, and maintenance metrics of all heavy equipment or machinery used. In conventional technologies, the productivity, efficiency, and maintenance metrics are determined by calculating the distance traveled by the machine from a first location to a second location using, for example, GPS systems, and by calculating the duration for which the equipment or machine has been functional. While this may be sufficient for machines like trucks, it is not sufficient for excavators or loaders which may be productively working while stationary in the same area, and which, unlike trucks, may not cover large distances, leading to erroneous interpretation of the performance For several construction machines like excavators and loaders, the function of the machine is not just traveling from point A to point B, instead, the function is also performed by moving parts like boom, arm, and bucket.

The existing methods, include, various sensors placed at various parts of a machine to measure the productivity, efficiency, and maintenance metrics. However, it is difficult to use the data from so many sensors when project sites have multiple machines of different manufacturers. Moreover, sensors do not capture any external context of the project site. The external context of the project site includes the work being done by the machines, for example, loading of the trucks, preparing stockpiles, digging material, etc. The external context of the project site also includes the type of material and information about interaction with other machines. In existing technologies, the machines do not capture the external context of the project site.

In addition to above problems, the construction and mining industries have a high level of variability between projects, making it very difficult for managers to successfully execute projects in a timely and economical manner. This variability stems from the vast number of influencing variables including but not limited to designs, location, geology, task breakdown, available resources, and specific constraints and hurdles. With an analogy to any other manufacturing industry, construction and mining projects operate in the ‘prototype’ phase, with the same level of uncertainty and variability. This variability makes it extremely challenging for managers to successfully plan, delegate tasks, and execute.

Furthermore, in the construction industry, the definition of appropriate work tasks can be a laborious and tedious process. It also represents the necessary information for the application of formal scheduling procedures. Since construction projects can involve thousands of individual work tasks, this definition phase can also be expensive and time-consuming.

While the repetition of activities in distinct locations or reproduction of activities from past projects reduces the work involved, there are very few computer aids available today, for the process of defining activities. Databases and information systems can assist in the storage and recall of the activities associated with past projects. However, for the important task of defining activities, reliance on the skill, judgment, and experience of the construction planner still continues to be a major part of planning

### SUMMARY

This summary is provided to introduce a selection of concepts in simple manners that are further described in the detailed description of the disclosure. This summary is not intended to identify key or essential inventive concepts of the subject matter nor is it intended to determine the scope of the disclosure.

To overcome at least some of the above-mentioned problems, it is preferable to have a system and method for measuring the activity of individual parts of a machine, while at the same time correlating with the external context of the project site. It is preferable to have gamified project management and execution in the construction and mining industries for improved outcomes. It is preferable to have a method for detecting machine states derived from machine-operations, machine activities, and work activities, using computer vision and inertial sensing for heavy machines with moving parts. To overcome at least some of the above-mentioned problems, it is preferable to have a system and method for machine state detection using computer vision combined with inertial sensing.

Briefly, according to an exemplary embodiment, a method for managing construction and mining projects through a gamification process using computer vision and inertial sensing is disclosed. The method includes detecting automatically, a plurality of machine-operations and work-activities by an electronic computing device mounted on a construction or mining heavy machine. The electronic computing device comprises at least one camera and one six-axis inertial sensor and is configurable to perform computer vision and machine learning through neural networks and state-machine logic for detecting the plurality of machine-operations and work-activities of the construction or mining heavy machine and gamifying construction and mining work-activity management based on the plurality of machine-operations and work-activities.

Briefly, according to an exemplary embodiment, a system for managing construction and mining projects, using computer vision and inertial sensing through gamification is disclosed. The system includes a physical electronic computing device, comprising at least one camera and at least one six-axis inertial sensor, mounted on a machine operating for construction and mining projects. The physical electronic computing device is configured for performing steps of detecting automatically, a plurality of machine-operations and work-activities; wherein the electronic computing device comprises at least one camera and one six-axis inertial sensor and is configurable to perform steps associated with computer vision and machine learning through neural networks and state-machine logic. The system includes a server comprising a processor, the processor in communication with a memory, the memory storing plurality of modules for executing the gamification logic for gamifying construction and mining work-activity management based on the plurality of machine-operations and work-activities.

The summary above is illustrative only and is not intended to be in any way limiting. Further aspects, exemplary embodiments, and features will become apparent by reference to the drawings and the following detailed description.

### BRIEF DESCRIPTION OF THE FIGURES

These and other features, aspects, and advantages of the exemplary embodiments can be better understood when the following detailed description is read with reference to the accompanying drawings in which like characters represent like parts throughout the drawings, wherein:

FIG. 1 is a block diagram of a system configured for managing a construction and mining project through a gamification logic, implemented according to an embodiment of the present disclosure;

FIG. 2A is an exemplary illustration of a system for machine state detection, implemented according to an embodiment of the present disclosure;

FIG. 2B is an exemplary illustration of a system for machine state detection, implemented according to an embodiment of the present disclosure;

FIG. 3 is an exemplary illustration of an architecture for automatic work-activity detection, implemented according to an embodiment of the present disclosure;

FIG. 4 is an exemplary illustration of a state machine diagram for machine activity detection, implemented according to an embodiment of the present disclosure;

FIG. 5 illustrates a schematic working of modules of the gamification, implemented according to an embodiment of the present disclosure;

FIG. 6 illustrates an exemplary gamification machine with sensors, camera, and antenna, implemented according to an embodiment of the present disclosure;

FIG. 7A illustrates a typical machine cabin fitted with a tablet, implemented according to an embodiment of the present disclosure;

FIG. 7B illustrates an office view for managing the gamification process, implemented according to an embodiment of the present disclosure;

FIG. 8 illustrates a schematic view of the working of the gamification, implemented according to an embodiment of the present disclosure;

FIG. 9 illustrates an example view of a tablet providing various inputs to a project manager, implemented according to an embodiment of the present disclosure;

FIG. 10 is a flow chart illustrating method steps for managing a construction and mining project through a gamification logic;

FIG. 11 is a flow chart illustrating method steps for implementing a gamification logic; and

FIG. 12 is a block diagram of an electronic device, implemented according to an embodiment of the present disclosure.

Further, skilled artisans will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having the benefit of the description herein.

### DETAILED DESCRIPTION

For the purpose of promoting an understanding of the principles of the invention, reference will now be made to the embodiments illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not comprise only those steps but may comprise other steps not expressly listed or inherent to such process or method. Similarly, one or more devices or sub-systems or elements or structures or components proceeded by “comprises... a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this invention belongs. The system, methods, and examples provided herein are illustrative only and not intended to be limiting.

In addition to the illustrative aspects, exemplary embodiments, and features described above, further aspects, exemplary embodiments of the present disclosure will become apparent by reference to the drawings and the following detailed description.

Embodiments of the present disclosure particularly disclose a system and a method for machine state detection using computer vision combined with inertial sensing. The system uses neural networks (machine learning) for machine state detection. Machine-mounted camera(s) capture a video stream of the movements of the machine, its parts, and its surroundings. An onboard computing unit on the machine has an inertial sensor incorporated with a 3-axis accelerometer and a 3-axis gyroscope. The onboard computing unit also referred to as edge computing devices has a processor to process the video frames and inertial frames using computer vision neural network (machine learning) and a hierarchy of machine states. The machine state can be derived from machine-operations, machine activity, and work-activity semantic data. Determining the machine state includes detecting objects such as bucket or boom, detecting machine-operations like the movement of objects concerning the contextual environment, detecting machine activities like a sequence of machine-operations like digging, loading, etc., that add up to an activity, and determining work-activity and context like loading truck, digging at mine, picking up material from a stockpile, etc.

In some embodiments, the word ‘machines’, ‘equipment's’, ‘heavy vehicles’ and ‘heavy equipment’ used in the description may reflect the same meaning and may be used interchangeably. In some embodiments, the word ‘player’, ‘operator of machine’ used in the description may reflect the same meaning and may be used interchangeably. In some embodiments, the word ‘onboard computing unit’, ‘edge computing devices” and “ physical electronic device” used in the description may reflect the same meaning and may be used interchangeably. Embodiments of the present invention will be described below in detail with reference to the accompanying figures.

To further clarify advantages and features of the present invention, a more particular description of the invention will be rendered by reference to specific embodiments thereof, which is illustrated in the appended figures. It is to be appreciated that these figures depict only typical embodiments of the invention and are therefore not to be considered limiting of its scope. The invention will be described and explained with additional specificity and detail with the accompanying figures.

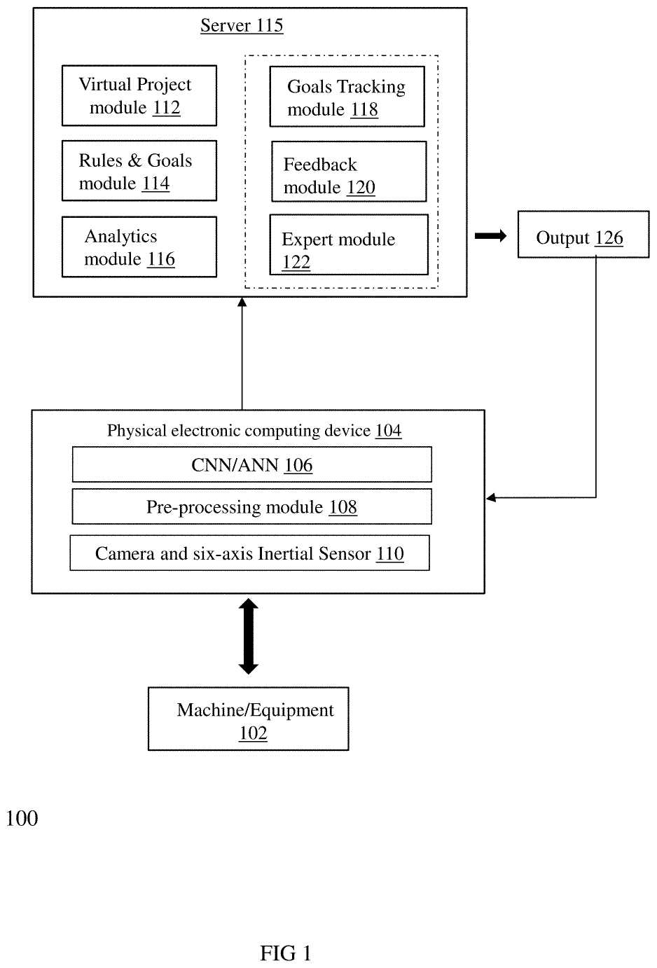

FIG. 1 is a block diagram of a system 100 for managing a construction and mining project through a gamification logic, implemented according to an embodiment of the present disclosure. In particular, FIG. 1 illustrates a machine 102, a physical electronic device 104 and a server 115. The physical electronic device 104 includes at least one camera and at least one six-axis inertial sensor, mounted on the machine 102 operating for construction and mining projects, a pre-processing module 104, and machine learning modules 106. The server 115 includes a processor, the processor in communication with a memory, the memory storing plurality of modules for executing the gamification logic for gamifying construction and mining work-activity management based on the plurality of machine-operations and work-activities. The plurality of modules include virtual project module 112, a rules and goals module 114, an analytics module 116, a goal tracking module 118, a feedback module 120, and a pre-configured expert module 122. Each block is described in detail below.

In one example, the machine 102 is a construction or mining heavy machine such as, excavators, backhoes, bulldozers, trenchers, loaders, tower cranes, dump trucks. The physical electronic device 104 includes at least one camera and at least one six-axis inertial sensor, mounted on the machine 102 operating for construction and mining projects, the pre-processing module 104 and machine learning modules 106. The physical electronic device 104 is configurable to perform computer vision and machine learning through neural networks and state-machine logic for detecting the plurality of machine-operations and work-activities of the construction or mining heavy machine 102.

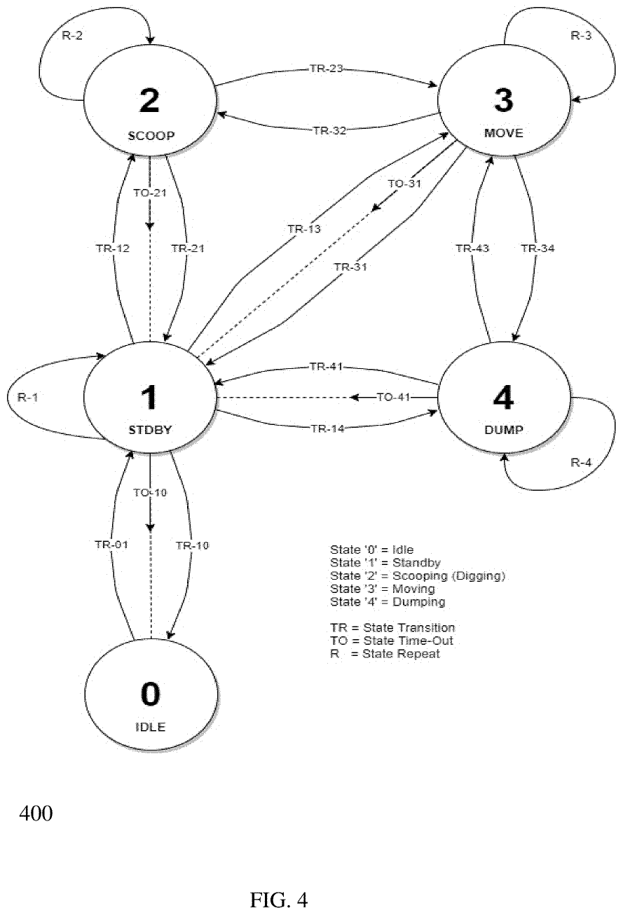

The pre-processing module 104 is embedded in the physical electronic computing device 104 which is mounted on the construction or mining heavy machine 102 and is configured for feeding plurality of heterogeneous data comprising inertial frames and image frames fused in real-time to the machine learning modules 106. The electronic computing device 104 comprises at least one camera and one six-axis inertial sensor and is configurable to perform computer vision and machine learning through neural networks and state-machine logic for detecting the plurality of machine-operations and work-activities of the construction or mining heavy machine 102. The state-machine logic is explained in detail in FIG. 4. and description associated with the FIG. 4.

The inertial frames of low-frequency are derived by arranging inertial pixels which in turn are obtained from statistical properties of high-frequency acceleration and angular-velocity corresponding to time-slot of each inertial frame. The heterogeneous data comprising inertial frames and image frames are synchronized by timestamping the data-polling process. At this step, the inertial signatures from multiple related inertial parameters are derived to form a cadence, wherein each signature provides identification of the type of work the machine is doing, estimating risk-index of the machine operators, and computing figure-of-merits with regard to energy efficiency, machine longevity, and time optimization.

The computer vision and machine learning modules 106 are configured for automatic detection of the plurality of machine-operations and work-activities. The computer vision and machine learning modules 106 are configured to determine a hierarchy of machine states and their activities using a hierarchical approach. The computer vision and machine learning modules 106 are configured to detect the state of each moving part of the machine using the plurality of heterogeneous data. The computer vision and machine learning modules 106 are configured to accurately identify and classify relevant parts of the machine 102 and further analyze various parameters, including but not limited to productivity, efficiency, and maintenance metrics of the machine 102.

The machine learning module 106 is configured to detect each work activity by combining detected machine-operation with additional contextual data derived from one or more visual or geo contexts or both.

Work-activity is a domain and job/work-specific outcome. Each machine 102 or equipment does specific actions to perform a unit of work-activity on a project site. There are several challenges for automatically detecting such work activities using computer vision. Work being context-specific, there is a need to sense the environment in which a machine 102 is working. The sensed information is the context that defines a particular work-activity.

Machine operations are operations that are done on a machine 102 by an operator, and it makes the machine 102 produce a certain operation like bucket curling, swinging, and idling. Further, machine operations are composed of a temporal sequence of objects and key points. The object to be detected for a front loader is the bucket that performs the machine operations. Key points are points within or on a bucket that can encode the movement that the bucket performs.

It is to be noted that the output of the computer vision and machine learning modules 106 are provided as input for the gamification in the server 115 to manage the construction and mining work-activity.

The plurality of modules for gamification include the virtual project module 112, the rules and goals module 114, the analytics module 116, the goal tracking module 118, the feedback module 120, and the pre-configured expert module 122.

The rules and goals module 114 is implemented for gamifying the construction and mining work-activity management for performing said steps of defining a plurality of rules, goals, and objectives for each player operating the machine 102 by a rules and goals module, creating project design for managing the construction and mining project, based on the details of each player operating the machine and details associated with machine by the rules and goals module and calculating achievable micro-goals for each player to effectively achieve the final project goals.

An analytics module 116 is implemented for monitoring a plurality of key metrics from each player, the machine 102, and the operation field based on the output of the machine learning modules. The virtual project module 112 is implemented for creating a digital twin of the construction and mining project based on a current status of the operation field, intended final project design, and a subsequent work required to achieve the goal of the intended final project.

The goal tracking module 118 is implemented for tracking goals based on metrics derived from the analytics module. In addition to above, gamifying the construction and mining work-activity management comprises augmenting output of the machine learning modules with a set of self-learning algorithms by the pre-configured expert module 122 to provide one or more decisions. The pre-configured expert module 122 is configured for converting one or more decisions into the gamification process, wherein the gamification process act as a feedback module 122 to the rules and goals module 114. Each player operating the machine 102 are scored and rewarded with points based on their performance.

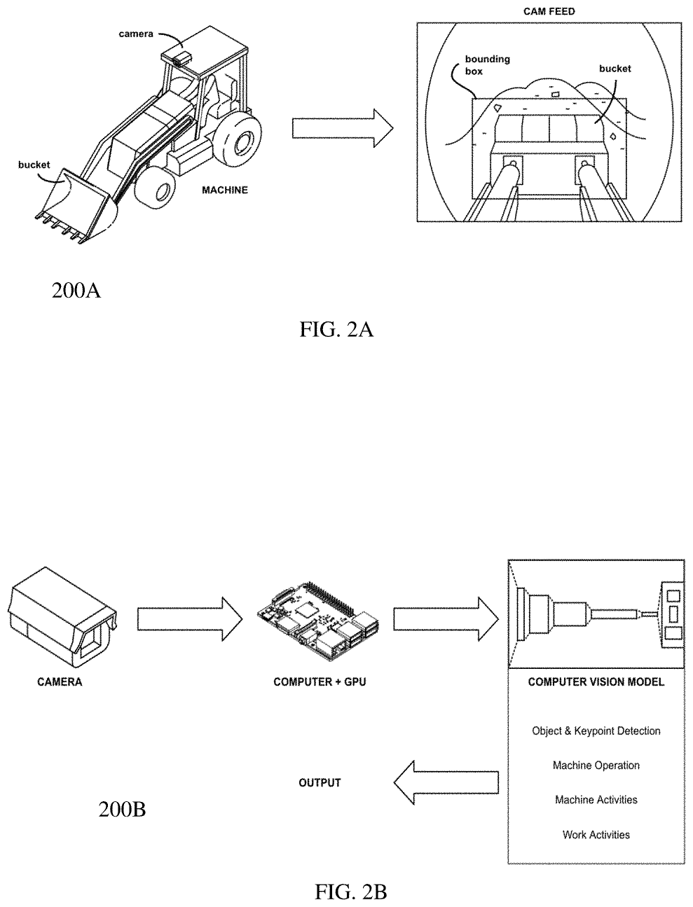

FIG. 2A is an exemplary illustration of a system 200A for machine state detection, implemented according to an embodiment of the present disclosure. FIG. 2B is an exemplary illustration of a system 200B for machine state detection, implemented according to an embodiment of the present disclosure.

FIG. 2A and FIG. 2B are an illustration of a system for machine state detection. The primary object of the present disclosure is to provide a system for machine state detection of heavy machinery with moving parts, for example, excavators, using computer vision. Computer vision involves using digital images from cameras, and videos, and analyzing the images and videos with neural networks, machine learning, and other deep learning models to accurately identify and classify objects and further analyze for various parameters like productivity, efficiency, and maintenance metrics of machines.

FIG. 2A depicts an excavator. The machine, i.e., excavator, has a camera mounted on it, an antenna (not shown) to send data for remote monitoring and analytics, and an onboard computing unit. Machine-mounted camera(s) capture a video stream of the movements of the machine, its parts, and its surroundings. The onboard computing unit has an inertial sensor incorporated with a 3-axis accelerometer and a 3-axis gyroscope. The onboard computing unit (computer+GPU) in FIG. 2B, also referred to as physical electronic computing device has a processor to process the video frames and inertial frames using computer vision neural network (machine learning) algorithms and a hierarchy of machine states. The machine state can be derived from machine-operations, machine activity, and work-activity semantic data, Determining the machine state includes object detection such as bucket or boom, detecting machine-operations like the movement of objects concerning the contextual environment, detecting machine activities like a sequence of machine-operations like digging, loading, etc., that add up to an activity, and determining work-activity and context like loading truck, digging at mine, picking up material from stock-pile, etc.

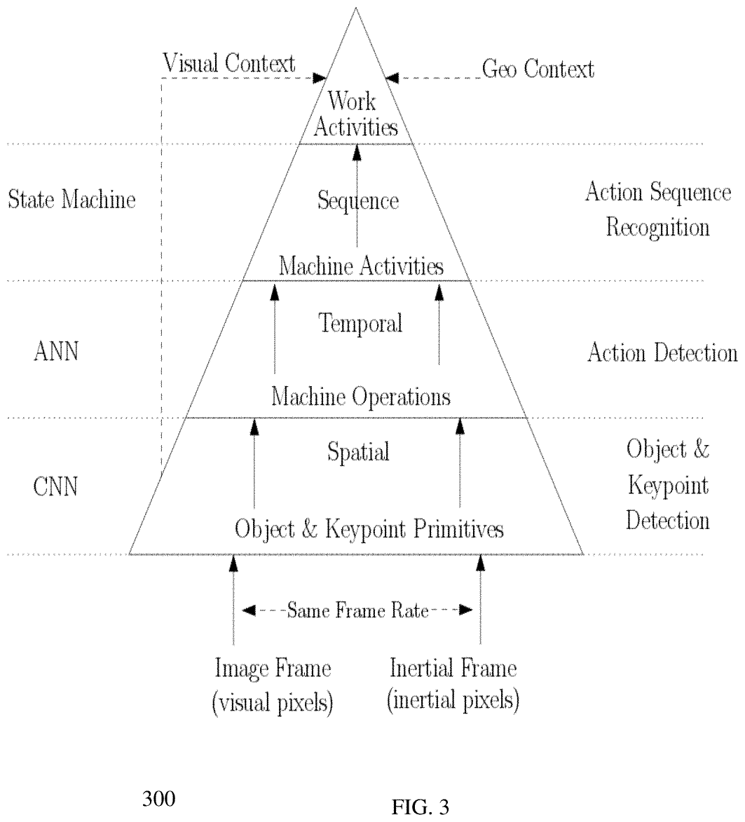

FIG. 3 is an exemplary illustration of an architecture 300 for automatic work-activity detection, implemented according to an embodiment of the present disclosure,

Work-activity is a domain and job/work-specific outcome. Each machine or equipment does specific actions to perform a unit of work-activity on a project site. There are several challenges for automatically detecting such work activities using computer vision. Work being context-specific, there is a need to sense the environment in which a machine is working. The sensed information is the context that defines a particular work-activity. Therefore, the task of work-activity detection can be broken up into context sensing and. machine activity detection.

Context sensing can again be visual or geo context. Visual context refers to the sensed information as seen by a camera. Geo context refers to GPS location, speed, and bearing. Machine activity refers to the activity performed by a machine. Different machines perform different activities. Hence, they need different models to detect their activity. In the present disclosure, machine activities are determined for three different machines, for example, Front Loaders, Excavators, and Haul Trucks. Front Loaders perform machine activities like digging, dumping, hauling, and idling. Work-activity for a front loader can be dumping-truck, dumping-plant, stockpiling, etc.

The present disclosure discloses mounting a camera with an embedded system on top of the machine to view, process, and detect the machine activity. Alongside, inertial pixels are sampled at an appropriate pixel rate to form an inertial frame which is at the same frame rate as that of the video stream. A fusing (combining) of the image frames and inertial frames forms the input data to the Neural Networks. Typically, the task of detecting machine activity is approached as a video action classification problem. Techniques like recurrent neural networks (RNNs) are used to solve this problem. However, the action is fine-grained, and the movement is minute to detect using classical or deep learning techniques.

As shown in FIG,3, a hierarchical approach is used for detecting work-activities. Work activities are composed of machine activities and context. Machine Activities are composed of machine-operations. Machine-operations are operations that are done on a machine by an operator, and it makes the machine produce a certain operation like bucket curling, swinging, and idling. Further, machine-operations are composed of a temporal sequence of objects and key points. The object to be detected for a front loader is the bucket that performs the machine-operations. Key points are points within or on a bucket that can encode the movement that the bucket performs.

The task of detecting work-activities starts with detecting the bucket object and key points using a Convolutional Neural Network (CNN). In one exemplary embodiment of the present disclosure, a Single Shot Detector (SSD) with MobilenetV2 is used as a backbone to detect the object-bounding boxes. Key points are detected similarly. The detected object position changes spatially as the machine operates. The spatial coordinates are fed to the next stage for machine-operation detection. In one embodiment, the temporal sequence of buckets is fed to a NasNet CNN for feature extraction, followed by a couple of fully connected (FC) layers. The inertial frame data is appended to these features. The temporal sequence of features is concatenated to an FC layer for classification of the machine-operation. For a front loader, the machine-operations are divided into four categories. They are bucket-curl, bucket pose, bucket-swing-x, and bucket-swing-y. The bucket-curl can be either curl-in, curl-out, or curl-idle. The bucket-pose can be either of charge, discharged, or hold. Bucket-swing-x and bucket-swing-y can be a movement to the left or right, or up and down, respectively. At the third stage, the sequence of machine-operations is fed to a state-machine to detect the Machine Activities. The machine activities are combined with the context information to obtain the work-Activities. The visual context is in the form of detected objects other than those of the machine, like people, trucks, stock-pile, plant, etc.

FIG. 4 is an exemplary illustration of a state machine diagram 400 for machine activity detection, implemented according to an embodiment of the present disclosure.

In deep learning literature, activity detection is addressed as a sequence classification problem. In the present disclosure, the task of activity detection is broken down into minute tasks based on domain expertise. A hierarchical bottom-up approach is implemented to classify a segment of the video into actions. The bottom-most step detects primitives consisting of objects and their key points. Fine-grained machine-operations are detected based on these primitives along with video data using MLP posed as a classification problem. Finally, at the top, the obtained machine-operations are fed to a deterministic state machine for activity recognition or detection. Machine activity detection uses heterogeneous blocks like—object primitives, feature primitives, Multi-Layer-Perceptron (MLP) based actions, and finally a state-machine. Machine Activity is composed of a sequence of machine-operations as discussed earlier.

In the present disclosure, machine-operation detection is achieved with video frames along with inertial frames synchronously and the machine activities are detected by a deterministic state machine. In typical sequence recognition problems, for any given event sequence, although the individual elements (events) are time-elastic in nature the sequence is strongly definable as there is not much event-noise anticipated. The presence of event noise is a challenge in detecting machine activities in our use case. Some of the examples are:

Example-1: In the case of a front-loader, the scooping is not expected while the machine is moving even at moderate speeds, and the scooping is ideally done while the machine is slowly moving forward.

Example-2: The front loader is expected to carry a load with the boom lowered. But the practical exceptions are when the heap and the truck to be loaded happen to be very close by.

FIG. 4 shows the state machine to recognize or detect machine activity from a sequence of machine-operations. The state machine contains transitions to and from one state to another. It also contains time-out conditions to return to a default state. The repeat conditions enforce the activity to continue if a particular sequence of machine-operations repeats in a. meaningful way. All the transitions are based on conditions from the outputs of the machine-operations stage.

Context plays a crucial role in the practical application of machine learning algorithms in the real world. In this problem, the task of detecting work-activity performed by a machine makes use of visual and geo contexts. The visual context consists of objects present in a scene, while the geo context consists of machine GPS location, speed, and bearing. Context is fused with machine activities to classify a segment of the video into a work-activity. For example, a dumping machine activity can be into a heap or a truck. The visual and geo context help to distinguish the machine activity into a specific work-activity.

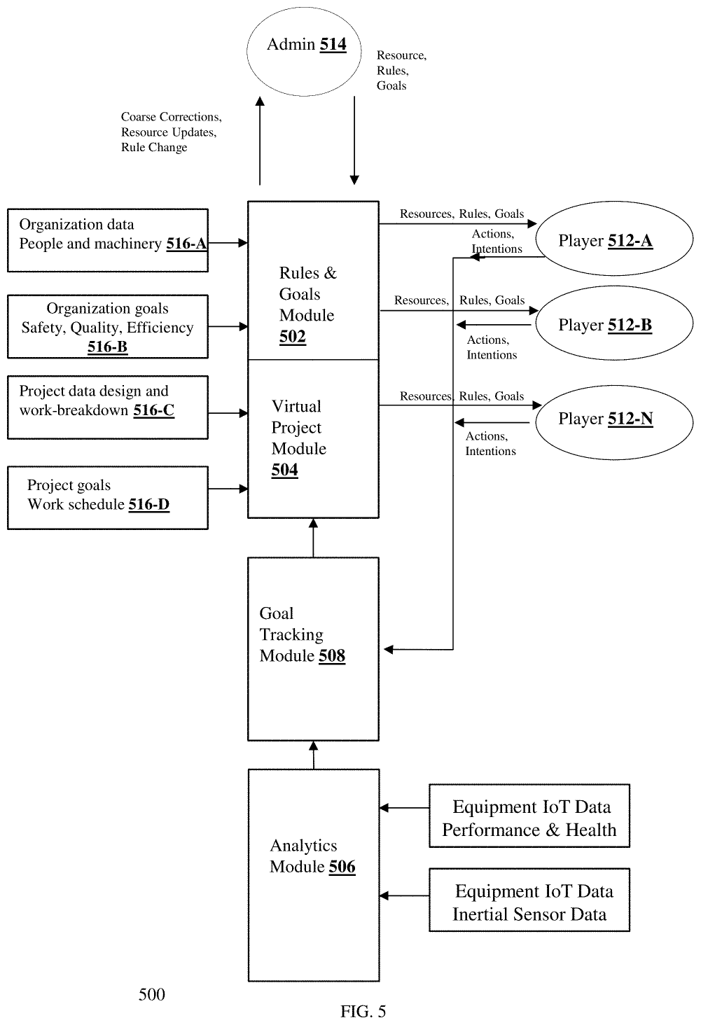

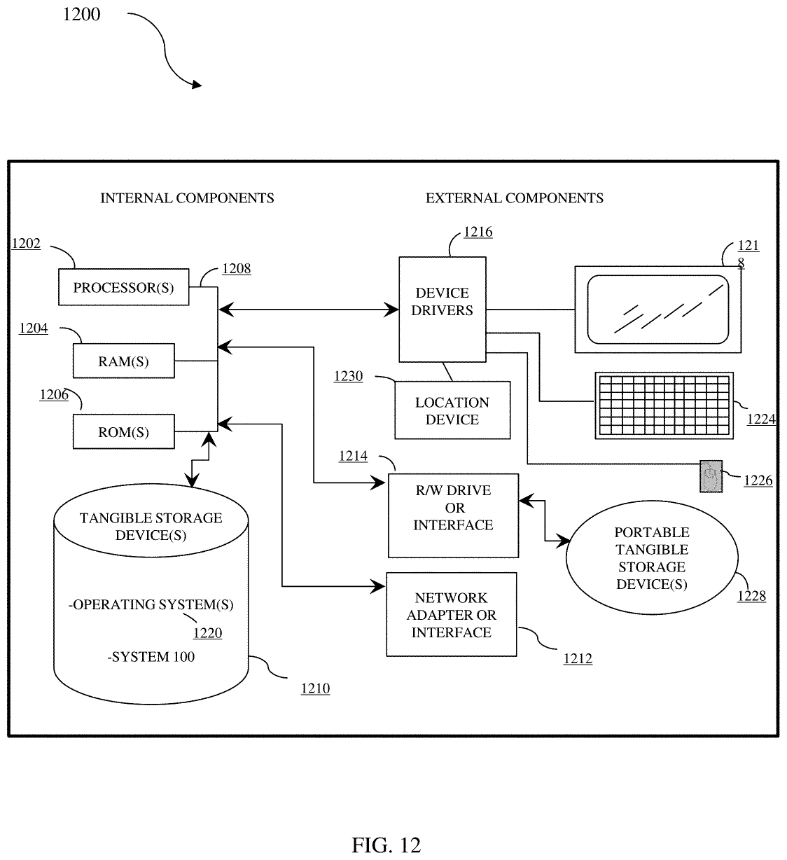

The above-described system 100 for managing a construction and mining project includes a gamification logic 500, which is described in detail below in FIG. 5 and FIG. 12. The system 100 is communicatively coupled, at least intermittently, to the server 115. The server includes a processor 115, the processor 115 in communication with a memory, the memory storing instructions for executing the gamification logic for managing the construction and mining project.

FIG. 5 illustrates a schematic working of modules of the gamification logic, implemented according to an embodiment of the present disclosure. FIG. 5 depicts a combined functioning of the four gamification modules that are depicted herein. Primarily there are four associated gamification modules. They are rules and goals module 502, virtual project module 504, analytics module 506 and goal tracking module 508.

The rules and goals module 502 include all rules, goals and objectives, project design and details, details of player (512-A-N), and equipment details. The rules and goals module 502 also computes achievable micro-goals for individual players (512-A-N) to achieve the final project goals.

The virtual project module 504 creates a digital twin of the project based on the current status of the site, final project design, and the subsequent work required to achieve the end-goal of the project.

The goal tracking module 508 tracks goals based on metrics derived from the work analytics module 506. The goal tracking module 508 also makes the rewards and nudges to incentivize players (512-A-N) towards the successful completion of goals. The analytics module 506 monitors all key metrics from people, equipment, and field, via computer vision-enabled cameras, IoT devices, and surveying equipment.

Initially, a digital virtual model is created in the virtual project module 504 based on the initial project site configuration. The initial project site configuration may be surveyed using aerial or terrestrial equipment/s. Based on the created digital virtual model, 3D engineering drawings for the desired end result of the project were drawn.

A project owner or administrator 514 can choose to use the system for diverse levels of planning For example, the project owner may use the system for complete planning, scheduling, and allocation of micro goals and tasks, or to manually supply the system with macro-goals. The macro-goals can be manually set by the project owner by manipulating the virtual model of the current site to reflect the desired end result of the macro-goal. If the project owner decides to allow the system to create all the macro-goals, the goals module 502 would create the macro goals based on the desired end result of the entire project. Once macro-goals are created, the gamification logic may break down each macro-goal into micro-goals that can be assigned as tasks to players (512-A-N). The progress on these goals will be reflected by goal-tracking metrics and data from the IoT devices in the physical electronic device and surveying equipment. The virtual model may be updated with changes based on the information from the analytics module 506, by way of the IoT devices and surveying equipment. The modules in the gamification logic 500 converts macro-level goals into micro-level goals for individual players (512-A-N) such as operators, foremen, and staff, based on the prior performance metrics of individual people and equipment. Micro-goals can be set based on the achievability of the goals are based on the capability of people and equipment and can be dynamically adjusted to achieve the macro-goals.

Player (512-A-N) and equipment suitability can be based on capability profiles, location, and other contextual factors such as weather, terrain, and logistics. Goals can be optimized for quality, speed, and/or cost-effectiveness, depending on the priority set by the administrator 514. The rules may also be set based on resource constraints. Additional micro-goals consistent with the macro-goals can also be created by individual players (512-A-N). The system 500 is capable of dynamically modifying micro-goals based on the achievement or failure of other prior micro-goals.

The gamification system 500 also provides a facility to enable the guidance to operators (512-A-N). Operators (512-A-N) of heavy machines such as excavators, haul trucks, and loaders have a challenging job with a high degree of variability. The operators (512-A-N) also need to work in coordination with other operators to together achieve project/site goals. They need to keep track of tasks, and their performance against those tasks, coordinate with managers and other operators (512-A-N) and also need to have visual feedback on performance and coordination.

Traditionally, the site managers were assigning tasks to (512-A-N) at the start of the day and then coordinate with each player via walkie-talkies. OEMs have in-cab screens to show material weight handled, number of passes, etc. However, the traditional system is a closed system that doesn't capture any contextual data and doesn't include real-time communication. In the currently developed system, an operator guidance system tracks the real-time performance of the entire site and dynamically performs course correction and alters plans that involve multiple operators (512-A-N). The system includes an electronic tablet mounted in-cab, connected to an antenna for Wi-Fi/LTE/NB-IoT, camera(s), and sensors for contextual awareness and performance tracking.

The inputs to the gamification logic include organization data people and machinery 516-A, organization goals safety, quality, efficiency 516-B, project data design and work-breakdown 516-C, project goals work schedule 516-D.

The following is an example workflow that can be adapted for system 100 for managing a construction and mining project and that includes a gamification logic 500.

The managers use a mobile or a web application to assign tasks to individual operators (512-A-N) at the start of each day/week. These tasks may be changed anytime. The assigned tasks show up on the operator tablet, along with relevant contextual data, including location/maps/work-codes, etc.

The machine activities can be automatically detected using a disclosed system 100 having computer vision algorithms By additionally detecting visual context, and using GPS information, the goal tracking module 508 also helps in tracking work metrics and performance and provides real-time feedback similar to a fitness tracker. An in-cab tablet also allows for real-time voice or touch-based communication, tapping on predefined messages, tapping on a map, task list, etc.

Managers see real-time performance of the entire site and can dynamically make better decisions with visual and quantitative feedback. The work activities performed by an operator are automatically detected and quantified, which enable managers to provide guidance for improving their efficiency.

Using the present system, the capability of individual players (512-A-N) can be decided based on historical peak, median and average performance, along with taking into account various contextual circumstances such as equipment to be used, weather, health, etc. The capability of equipment can also be decided by the system based on historical peak, median and average performance, taking into account various contextual circumstances such as operator, weather, breakdown, maintenance issues etc. As more information from the project is collected by the Analytics module 506, machine learning algorithms are updated with the profiles of players (512-A-N) and equipment.

Machine-activities, visual context, and geo context are detected by one or more in-cab IoT edge devices. Machine-activities are detected by innovatively fusing or combining computer vision and inertial signatures through machine learning. Visual context is derived from object detection and classification using computer vision and machine learning. Geo (spatial) context is obtained from the GNSS module, and the data is automatically captured on the field, from the moving heavy-equipment, stationary plants, and fixed vantage points. The vantage points can include pole-mounted cameras, Aero-stat mounted cameras, or drone-mounted cameras. The cameras can be visible light cameras or LIDARs. All this data is captured in a manner that cannot be replicated by manual, human-driven processes. All of this data is ingested into the analytics module 506 after the data reaches the back-end systems.

All the actionable data is taken by the analytics module 506 and the metrics are forwarded to the goal tracking module 508, where the data is used to ascertain progress against micro-goals. The video data is used to detect objects. video and inertial data are used to recognize actions performed by various equipment used by the players (512-A-N). Machine-Learning algorithms can be derived, and machine-operations and work activities are derived by fusing Visual and Geo (GNSS) context data. Visual context includes objects like people, other equipment in the field, working material, material heaps, and any other cooperating equipment such as trucks. Geo contexts include plant area, special safety zones, path-way intersections, etc. All these are used to score players (512-A-N) automatically.

Signatures contain six-axis (3-axis acceleration and 3-axis gyro) inertial measurements and their elaborate meta-data. While each type of machine/equipment has a set of signatures associated with it (one for each function), the templates are different in that they are composite in nature that contains necessary inertial information that can be referenced to (compared with) any of the signature types in the system. Inertial Signatures are the reference templates containing multiple related inertial parameters forming a cadence (sequence and duration). Each signature represents one of the following:
i. to identify the type (kind) of work the heavy earth machine is doing.
ii to estimate risk-index of the machine operators (512-A-N).
iii. to compute figure-of-merits with regard to energy-efficiency, machine-longevity, and time-optimization.

Inertial Templates are derived directly from the live inertial data stream from the equipment and contain composite patterns of inertial data that can be used with any of the predefined signatures deployed in the current system. Feature extraction algorithm operates on periodic inertial telemetry data packets coming (in real-time as well as in batch mode) from the heavy equipment. The algorithm identifies patterns fitting a feature and prepares a template. Signature Matching algorithm takes Inertial Template as input and depending on the configuration will apply a set of reference signatures (Work-Type, Risk-Factor, etc.). The output of the algorithm is a score for every signature considered. The algorithm may further depend on the localization of signatures, terrain localization, weather localization, and specific machine models (from vendors).

The inertial signatures are fed to the machine learning models along with the video input. The models use the information together to predict the work activities which are in turn fed to the gamification logic.

The successful execution of goals and projects is incentivized by providing dynamic nudges, incentives, and rewards to the players (512-A-N). The targets (goals) vis-a-vis their incentives (rewards) may be varied dynamically through changing pre-conditions and implicit-goals (Rules). Examples of pre-conditions are (1) limiting the resources (opex, capex related) and (2) shrinking the timelines (most resource utilization). Without subjecting the players (512-A-N) to complex computations, the gamification logic guides (constrains/nudges) them to achieve the implicit goals of the organization by changing the rules of the game from time to time. The goal tracking module 508 may also be indirectly used to micromanage the kind of goals that players (512-A-N) set.

A typical example of how the gamification logic of the present invention would be used for managing a construction and mining project is described in detail below:

In a first step, an intended end-result of the project is imported into the virtual project module 504 as a virtual model, from an existing 3D digital visualization model. Then, the initial status of the project site is mapped using aerial or terrestrial surveying equipment and imported into virtual project module 504. The detailed work breakdown-structure (WBS) comprising of work-codes and activity-codes, and bill-of quantities (BOQ) comprising material-codes and quantities are imported into the rules and goals module 502. The project owner/administrator 514 sets the required optimization criteria for project execution by setting a weightage of importance to speed, cost-efficiency, quality, etc. on the rules and goals module 502. The list of players (512-A-N) including operators and project-staff and equipment (heavy-machinery and tools) are imported into the rules and goals module 502. These items will be profiled by the system over time. The rules and goals module 502 computes the detailed breakdown and schedule of all the tasks required to be completed for the project to be successfully executed. The rules and goals module 502 breaks-down the project execution goal into macro-goals for different milestones, and further into micro-goals for individual players (512-A-N) and equipment, based on sophisticated machine learning (ML) optimization algorithms, that consider the capability profiles of individual players (512-A-N) and equipment. Macro-goals can also be set manually by the administrator 514 by manipulating the project model on the virtual project module 504 to depict the required work done. The players (512-A-N) can find out their daily task-list from the goal tracking module 508 on their mobile or desktop computer and go ahead and complete the assigned work as per the micro-goals.

The analytics module 506 tracks micro-goals based on key metrics collected from the field, people, and equipment via sophisticated IoT (Internet-of-Things) sensors and machine-learning algorithms, as well as aerial or terrestrial surveying equipment. The future micro-goals can be modified dynamically by the rules and goals module 502 using sophisticated ML optimization algorithms to accommodate success and failure of past goals by players (512-A-N).

The goal tracking module 508 can nudge players (512-A-N) towards improved performance of goals based on gamification techniques such as rewards, quests, badges, milestones, awards, and leader boards. Once all the goals are completed, the project is considered to be successfully executed.

The static resource data (equipment, players, etc.) and the cumulative and real-time dynamic monitoring inputs of the system (tracking, telemetry, etc.) set an environment that is readily and easily visible for the player (512-A-N) to decide a ‘move’ leading to the set goal. The preconfigured expert-system is augmented with a set of self-learning algorithms that take into account the nature of a project, resource map, tightness (low-margin) of the goal setting, and even personal preferences.

The gamification logic described here can tremendously simplify the complexities and variabilities in planning, optimizing, and executing construction and mining projects. As such, this may be considered a possible vision for the future of these industries, to push them forward from the current highly-variable and prototype-style setup, to one that is exponentially more scalable, automated, and intelligent.

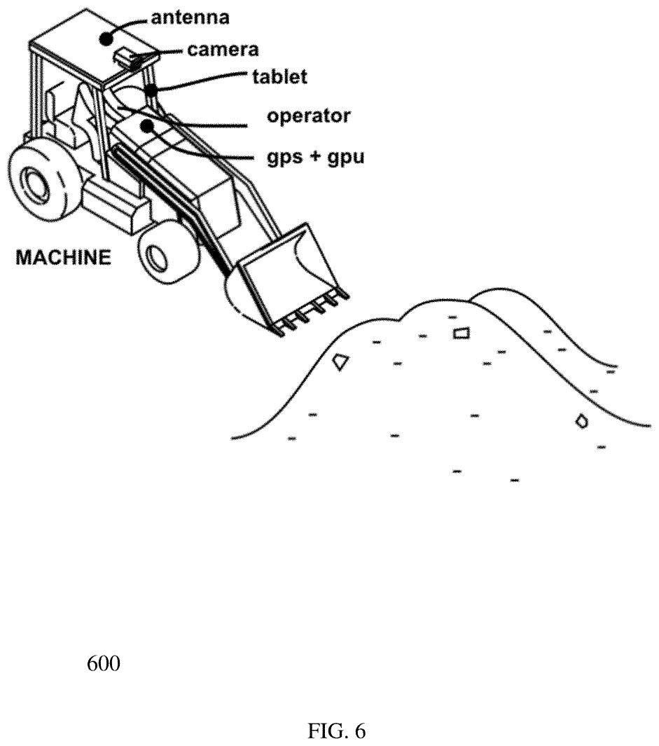

FIG. 6 illustrates an exemplary gamification machine 600 with sensors, camera, and antenna, implemented according to an embodiment of the present disclosure. In particular, FIG. 6 depicts an example of construction equipment (machine) which includes the gamification logic, implemented. The construction equipment (machine) is having at least an antenna, a camera, and a tablet or computer. The machine is also fitted with GPS and GPU equipment for providing the accurate position of the machine. The operator gets the required inputs and instructions through the fitted accessories and the tablet

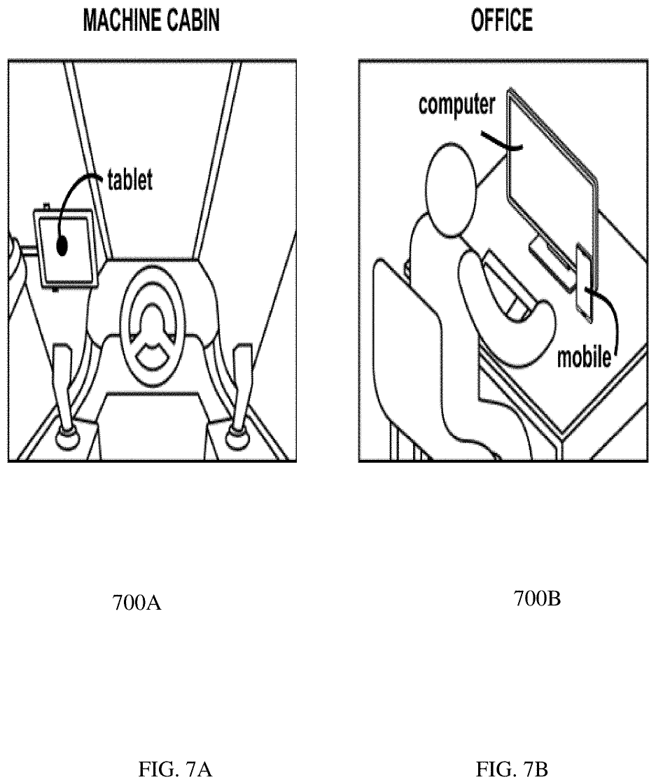

FIG. 7A illustrates a typical machine cabin fitted with a tablet, implemented. according to an embodiment of the present disclosure. FIG. 7B illustrates an office view for managing the gamification system, implemented according to an embodiment of the present disclosure.

In one example. FIG. 7A illustrates a tablet fitting in the machine and FIG. 7B illustrates an office environment where a project manager can access all the data of the machine and operator and provide instructions to the operator.

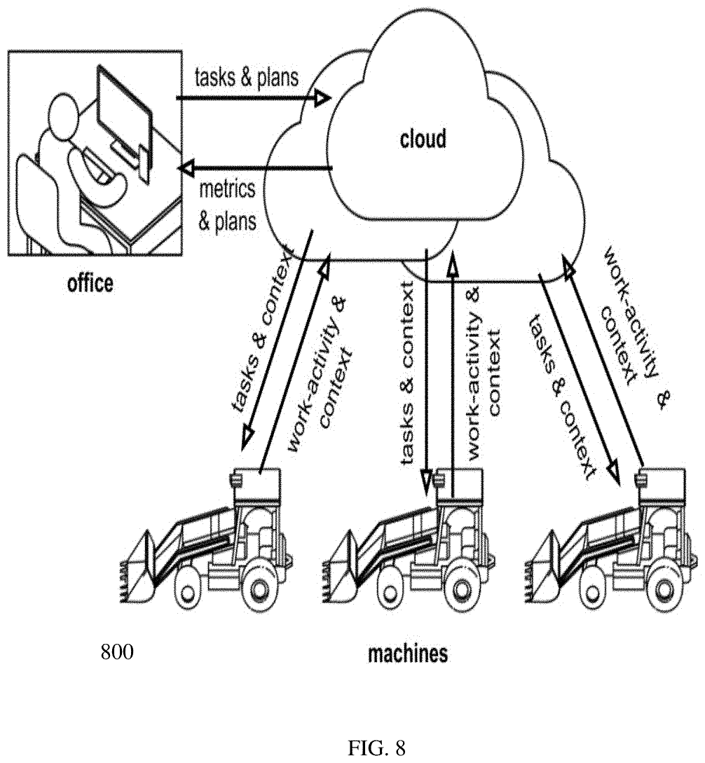

FIG. 8 illustrates a schematic view of the working of the gamification system, implemented according to an embodiment of the present disclosure, FIG. 8 schematically illustrates a typical communication system between the project manager and one or more machine operators. The communication can be cloud-based through the tablet or other similar operating machines fitted in the machines. The operators' machine may send the work activities and context to the project manager and receive tasks and context from the project manager through cloud-based communication.

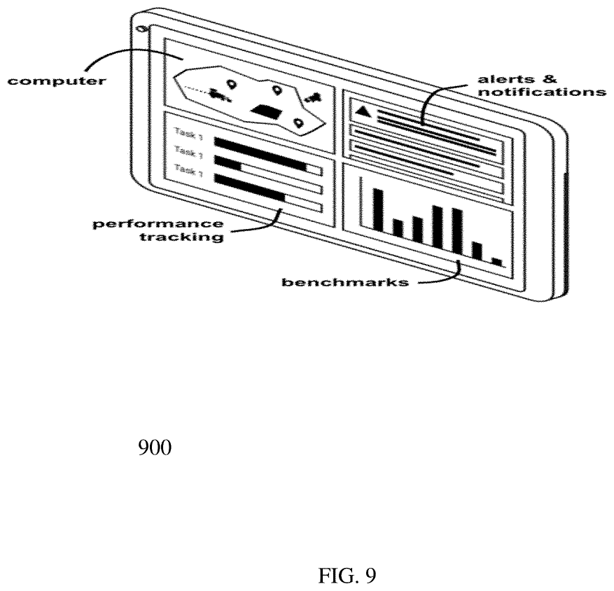

FIG. 9 illustrates an example view of a tablet providing various inputs to a project manager, implemented according to an embodiment of the present disclosure. In one example, a typical computer or tablet is configured to provide the project manager with the required information and contexts. Along with providing an overview of the works, the computer can also provide alerts and notifications and helps the manager to track performances and benchmark the works against set goals or other requirements.

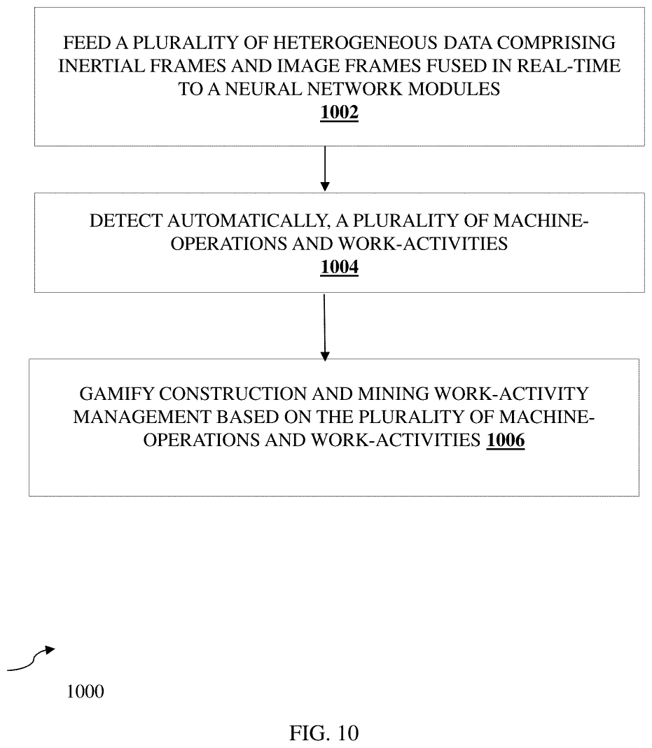

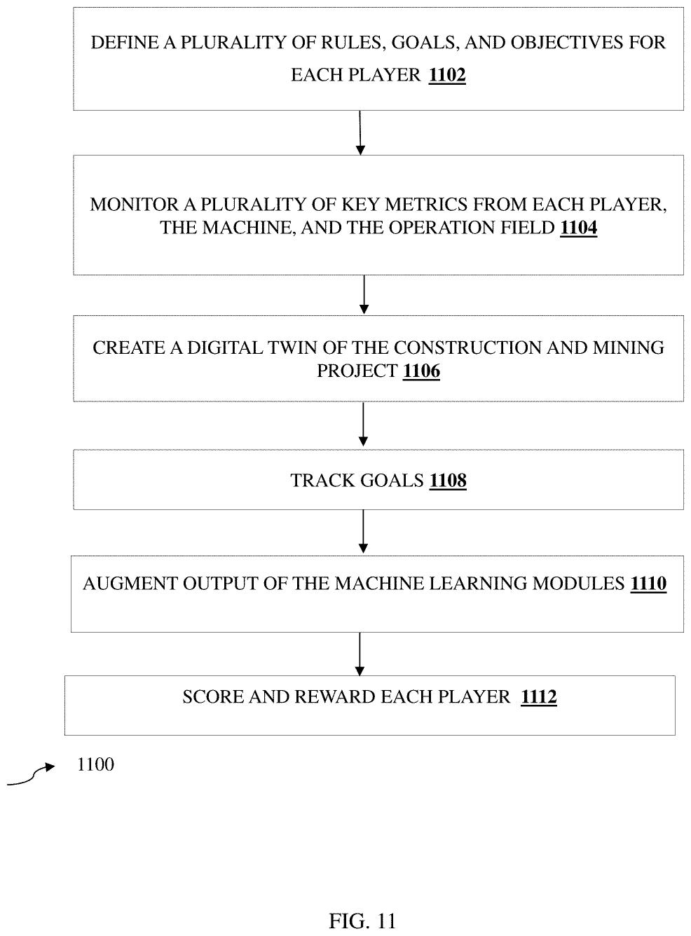

In some embodiments, the above-described system 100 and exemplary embodiments, may be implemented for monitoring heavy construction and mining machines and for managing construction and mining projects using computer vision and inertial sensing for heavy machines with moving parts along with gamification logic. The flow chart 1000 as explained below in FIG. 10, describes managing construction and mining projects using computer vision and inertial sensing for heavy machines with moving parts along with gamification logic. The flow chart 1100 as explained below in FIG. 11, describes the functions of the modules of the gamification for monitoring heavy construction and mining machines and for managing construction and mining projects.

FIG. 10 is a flow chart 1000 illustrating method steps for managing a construction and mining project through a gamification logic. In particular, FIG. 10 is a flow chart 1000 illustrating a method 1000 for managing construction and mining projects through a gamification process using computer vision and inertial sensing.

FIG. 10 may be described from the perspective of a processor (not shown) that is configured for executing computer readable instructions stored in a memory to carry out the functions of the modules (described in FIG. 1) of the system 100. In particular, the steps as described in FIG. 10 may be executed for managing construction and mining projects through a gamification process using computer vision and inertial sensing.

Each step is described in detail below.

At step 1102, a plurality of heterogeneous data comprising inertial frames and image frames fused in real-time are fed to a neural network module. At this step, a pre-processing module present in an electronic computing device mounted on a construction or mining heavy machine feeds plurality of heterogeneous data comprising inertial frames and image frames fused in real-time to a neural network module. In one example, the Artificial neural network (ANN) or convolutional neural network (CNN), known in the state of art may be implemented herein. The electronic computing device comprises at least one camera and one six-axis inertial sensor and is configurable to perform computer vision and machine learning through neural networks and state-machine logic for detecting the plurality of machine-operations and work-activities of the construction or mining heavy machine.

The inertial frames of low-frequency are derived by arranging inertial pixels which in turn are obtained from statistical properties of high-frequency acceleration and angular-velocity corresponding to time-slot of each inertial frame. The heterogeneous data comprising inertial frames and image frames are synchronized by timestamping the data-polling process.

At this step, the inertial signatures from multiple related inertial parameters are derived to form a cadence, wherein each signature provides identification of the type of work the machine is doing, estimating risk-index of the machine operators, and computing figure-of-merits with regard to energy efficiency, machine longevity, and time optimization.

At step 1104, a plurality of machine-operations and work-activities are detected automatically.

In one example, the automatic detection of the plurality of machine-operations and work-activities are performed using computer vision and machine learning modules.

The computer vision and machine learning modules are configured to determine a hierarchy of machine states (as described above in FIG. 3) and their activities using a hierarchical approach. The computer vision and machine learning modules are configured to detect the state of each moving part of the machine using the plurality of heterogeneous data. The computer vision and machine learning modules are configured to accurately identify and classify relevant parts of the machine and further analyze various parameters, including but not limited to productivity, efficiency, and maintenance metrics of the machine.

The machine learning module is configured to detect each work-activity by combining detected machine-operation with additional contextual data derived from one or more visual or geo contexts or both.

It is to be noted that the output of the computer vision and machine learning modules are provided as input for the gamification process to manage the construction and mining work-activity.

At step 1006, construction and mining work-activity management, is gamified based on the plurality of detected machine-operations and work-activities. The details for gamifying the construction and mining work-activity management are described in detail in FIG. 11 below.

FIG. 11 is a flow chart 1100 illustrating method steps for implementing a gamification logic. At step, 1102, a rules and goals module is implemented for gamifying the construction and mining work-activity management for performing said steps of defining a plurality of rules, goals, and objectives for each player operating the machine by a rules and goals module, creating project design for managing the construction and mining project, based on the details of each player operating the machine and details associated with machine by the rules and goals module and calculating achievable micro-goals for each player to effectively achieve the final project goals.

At step, 1104, an analytics module is implemented for monitoring a plurality of key metrics from each player, the machine, and the operation field based on the output of the machine learning modules.

At step, 1106, a virtual project module is implemented for creating a digital twin of the construction and mining project based on a current status of the operation field, intended final project design, and a subsequent work required to achieve the goal of the intended final project.

At step, 1108, a goal tracking module is implemented for tracking goals based on metrics derived from the analytics module. At step, 1110, output of the machine learning modules is augmented with a set of self-learning algorithms by a pre-configured expert module to provide one or more decisions, wherein the pre-configured expert module is configured for converting one or more decisions into the gamification process, wherein the gamification process act as a feedback module to the rules and goals module. At step, 1112, each player operating the machine are scored and rewarded with points based on their performance.

The system 100 and method 1000 and 1100 is configured for measuring the productivity, efficiency, and maintenance. The metrics of a heavy machine with moving parts can be easily and accurately achieved because of the camera with computer vision, wherein the camera is cheaper and can retrofit on any machine and can capture external context. In addition to camera, the inertial sensor information augments visual data for better activity recognition. The output of the system 100 is video and semantics and is human readable. The system 100 can be applied to any machine with moving parts. The system 100 can use LiDAR, a stereo camera to improve accuracies. The system 100 can do the computer vision on the cloud or external computer. The system 100 can apply this approach to any relevant video of the machine. The system 100 doesn't necessarily have to be ego-centric video (first-person camera).

FIG. 12 is a block diagram 1200 of a computing device utilized for implementing the system 100 of FIG. 1 implemented according to an embodiment of the present disclosure. The modules of the system 100 are described herein are implemented in computing devices. The computing device 1200 comprises one or more processor 1202, one or more computer readable memories 1204 and one or more computer readable ROMs 1206 interconnected by one or more buses 1208.

Further, the computing device 1200 includes a tangible storage device 1210 that may be used to execute operating systems 1220 and modules existing in the system 100. The various modules of the system 100 can be stored in tangible storage device 1210. Both, the operating system and the modules existing in the system 100 are executed by processor 1202 via one or more RAMs 1204 (which typically include cache memory).

Examples of storage devices 1210 include semiconductor storage devices such as ROM 1206, EPROM, EEPROM, flash memory, or any other computer readable tangible storage devices 1210 that can store a computer programs and digital data. Computing device also includes R/W drive or interface 1214 to read from and write to one or more portable computer-readable tangible storage devices 1228 such as a CD-ROM, DVD, and memory stick or semiconductor storage device. Further, network adapters or interfaces 1212 such as a TCP/IP adapter cards, wireless WI-FI interface cards, or 3G or 4G wireless interface cards or other wired or wireless communication links are also included in the computing device 1200. In one embodiment, the modules existing in the system 100 can be downloaded from an external computer via a network (for example, the Internet, a local area network or other, wide area network) and network adapter or interface 1212. Computing device 1200 further includes device drivers 1216 to interface with input and output devices. The input and output devices can include a computer display monitor 1218, a keyboard 1224, a keypad, a touch screen, a computer mouse 1226, or some other suitable input device.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. A method for managing construction and mining projects through a gamification process using computer vision and inertial sensing, the method comprising:
detecting automatically, a plurality of machine-operations and work-activities by an electronic computing device mounted on a construction or mining heavy machine, wherein the electronic computing device comprises at least one camera and one six-axis inertial sensor and is configurable to perform computer vision and machine learning through neural networks and state-machine logic for detecting the plurality of machine-operations and work-activities of the construction or mining heavy machine; and
gamifying construction and mining work-activity management based on the plurality of machine-operations and work-activities.

2. The method as claimed in claim 1, wherein a pre-processing module feeds plurality of heterogeneous data comprising inertial frames and image frames fused in real-time to a neural network modules.

3. The method as claimed in claim 2, wherein the inertial frames of low-frequency are derived by arranging inertial pixels which in turn are obtained from statistical properties of high-frequency acceleration and angular-velocity corresponding to time-slot of each inertial frame.

4. The method as claimed in claim 2, wherein the plurality of heterogeneous data comprising inertial frames and image frames are synchronized by timestamping the data-polling process.

5. The method as claimed in claim 1, comprising deriving inertial signatures from multiple related inertial parameters to form a cadence, wherein each signature provides:
identification of the type of work the machine is doing,
estimating risk-index of the machine operators, and
computing figure-of-merits with regard to energy efficiency, machine longevity, and time optimization.

6. The method as claimed in claim 1, wherein the automatic detection of the plurality of machine-operations and work-activities are performed using computer vision and machine learning modules, wherein computer vision and machine learning modules are configured to:
determine a hierarchy of machine states and their activities using a hierarchical approach;
detect the state of each moving part of the machine using the plurality of heterogeneous data; and
accurately identify and classify relevant parts of the machine and further analyze various parameters, including but not limited to productivity, efficiency, and maintenance metrics of the machine.

7. The method as claimed in claim 6, wherein the machine learning module is configured to detect each work-activity by combining detected machine-operation with additional contextual data derived from one or more visual or geo contexts or both.

8. The method as claimed in claim 6, wherein output of the computer vision and machine learning modules are provided as input for the gamification process to manage the construction and mining work-activity.

9. The method as claimed in claim 1, wherein gamifying the construction and mining work-activity management comprises:
defining a plurality of rules, goals, and objectives for each player operating the machine by a rules and goals module;
creating project design for managing the construction and mining project, based on the details of each player operating the machine and details associated with machine by the rules and goals module; and
calculating achievable micro-goals for each player to effectively achieve the final project goals by the rules and goals module.

10. The method as claimed in claim 1, wherein gamifying the construction and mining work-activity management comprises monitoring a plurality of key metrics from each player, the machine, and the operation field based on the output of the machine learning modules, wherein the monitoring is performed by an analytics module.

11. The method as claimed in claim 1, wherein gamifying the construction and mining work-activity management comprises creating a digital twin of the construction and mining project based on a current status of the operation field, intended final project design, and a subsequent work required to achieve the goal of the intended final project, wherein the digital twin is created by a virtual project module.

12. The method as claimed in claim 1, wherein gamifying the construction and mining work-activity management comprises tracking goals by a goal tracking module, wherein tracking goals is based on metrics derived from the analytics module.

13. The method as claimed in claim 1, wherein gamifying the construction and mining work-activity management comprises augmenting output of the machine learning modules with a set of self-learning algorithms by a pre-configured expert module to provide one or more decisions, wherein the pre-configured expert module is configured for converting one or more decisions into the gamification process, wherein the gamification process act as a feedback module to the rules and goals module.

14. The method as claimed in claim 1, wherein each player operating the machine are scored and rewarded with points based on their performance

15. A system for managing construction and mining projects, using computer vision and inertial sensing through gamification, the system comprising:
a physical electronic computing device, comprising at least one camera and at least one six-axis inertial sensor, mounted on a machine operating for construction and mining projects; wherein the physical electronic computing device is configured for performing steps of: detecting automatically, a plurality of machine-operations and work-activities; wherein the electronic computing device comprises at least one camera and one six-axis inertial sensor and is configurable to perform steps associated with computer vision and machine learning through neural networks and state-machine logic; and
a server comprising a processor, the processor in communication with a memory, the memory storing plurality of modules for executing the gamification logic for gamifying construction and mining work-activity management based on the plurality of machine-operations and work-activities.

16. The system as claimed in claim 15, wherein the construction and mining work-activity management is gamified in a software application's user interfaces and dashboards using the backend database present in the server.

17. The system as claimed in claim 15, wherein the physical electronic computing device comprises a pre-processing module configured to feed a plurality of heterogeneous data comprising inertial frames and image frames fused in real-time to neural network modules, wherein the inertial frames of low-frequency are derived by arranging inertial pixels which in turn are obtained from statistical properties of high-frequency acceleration and angular-velocity corresponding to time-slot of each inertial frame.

18. The system as claimed in claim 17, wherein the plurality of heterogeneous data comprising inertial frames and image frames are synchronized by timestamping the data-polling process

19. The system as claimed in claim 15, wherein the automatic detection of the plurality of machine-operations and work-activities are performed using computer vision and machine learning modules, wherein computer vision and machine learning modules are configured to:
determine a hierarchy of machine states and their activities using a hierarchical approach;
detect the state of each moving part of the machine using the plurality of heterogeneous data; and
accurately identify and classify relevant parts of the machine and further analyze various parameters, including but not limited to productivity, efficiency, and maintenance metrics of the machine.

20. The system as claimed in claim 15, wherein the plurality of modules for executing the gamification logic for gamifying construction and mining work-activity management based on the plurality of machine-operations and work-activities comprise:
virtual project module for creating a digital twin of the construction and mining project based on a current status of the operation field, intended final project design, and a subsequent work required to achieve the goal of the intended final project;
a rules and goals module for defining a plurality of rules, goals, and objectives for each player operating the machine, creating project design for managing the construction and mining project, based on the details of each player operating the machine and details associated with machine; and calculating achievable micro-goals for each player to effectively achieve the final project goals by the rules and goals module;
an analytics module for monitoring a plurality of key metrics from each player operating the machine, the machine, and the operation field based on the output of the machine learning modules;
a goal tracking module configured for tracking goals based on metrics derived from the work analytics module; and
a pre-configured expert module for augmenting output of the machine learning modules with a set of self-learning algorithms to provide one or more decisions, wherein the pre-configured expert module is configured for converting one or more decisions into the gamification process, wherein the gamification process act as a feedback module to the rules and goals module.
